(19) United States
(12) Patent Application Publication
(10) Pub. No.: US 2020/0042936 A1
(43) Pub. Date: Feb. 6, 2020

(54) FIELD EMPLOYEE SHIFT MONITORING AND TRANSPORTATION LOAD TRACKING WITH A MARKUP LANGUAGE GEOLOCATION METHOD

(71) Applicant: Shailendra Jain, Palo Alto, CA (US)

(72) Inventor: Shailendra Jain, Palo Alto, CA (US)

(21) Appl. No.: 16/597,851

(22) Filed: Oct. 10, 2019

Related U.S. Application Data
(63) Continuation-in-part of application No. 16/405,114, filed on May 7, 2019.
Application No. 16/405,114 is a continuation-in-part of application No. 16/131,495, filed on Sep. 14, 2018, now abandoned.
Application No. 16/131,495 is a continuation-in-part of application No. 14/289,496, filed on May 28, 2014, now abandoned.

(51) Int. Cl. G06Q 10/08; G06F 17/22; H04W 4/021; H04W 4/029; H04W 4/14; H04M 1/725; H04W 4/02; G06Q 10/10; G06Q 10/06

(52) U.S. Cl. CPC G06Q 10/0833; G06F 17/2235; G06F 17/2247; H04W 4/021; H04W 4/029; G06Q 10/063114; H04M 1/72552; H04W 4/025; H04M 1/72561; G06Q 10/1091; H04W 4/14

(57) ABSTRACT

In one aspect, a computerized method useful for implementing employee shift or transportation load tracking with the step of embedding a webpage-creation markup language hyperlink into a text message. The hyperlink includes encoded details of the employee ID, shift start/end time and tracking frequency request and opens a web page with an embedded markup language call to a geolocation application programming interface (API). The method includes the step of communicating the text message to a driver of a delivery vehicle. The method includes the step of displaying the text message to the driver with a mobile device of the driver. The method includes the step of detecting with the mobile device that the driver accessed the hyperlink in the text message. The method includes the step to embed logistics or shift parameters into the hyperlink. The method includes the step of causing the hyperlink to open the webpage.

### CROSS-REFERENCE TO RELATED APPLICATIONS

This application claims priority to and is a continuation-in-part of U.S. patent application Ser. No. 14/289,496, titled MESSAGING SERVICE FOR GEOFENCE-BASED AUTOMATIC TIME CLOCKING and filed on May 28, 2014. This application is hereby incorporated by reference in its entirety.

### BACKGROUND

### 1. Field

This application relates generally to location-based services, and more particularly to a system, method and article of manufacture of delivery tracking with a markup language geolocation methods.

### 2. Related Art

A company may have employees that work at remote job locations. The company may wish to track the employee's time at the remote job location. However, sign in sheets or other methods by which an employee clocks in may rely on the employee's self-reporting. Verification of such clock-in/clock-out methods may not be feasible and/or costly. Therefore, improvements to the methods and systems of tracking employee work time at remote job locations may prove beneficial.

### BRIEF SUMMARY OF THE INVENTION

In one aspect, a computerized method useful for implementing employee shift or transportation load tracking with the step of embedding a webpage-creation markup language hyperlink into a text message. The hyperlink includes encoded details of the employee ID, shift start/end time and tracking frequency request and opens a web page with an embedded markup language call to a geolocation application programming interface (API). The method includes the step of communicating the text message to a driver of a delivery vehicle. The method includes the step of displaying the text message to the driver with a mobile device of the driver. The method includes the step of detecting with the mobile device that the driver accessed the hyperlink in the text message. The method includes the step to embed logistics or shift/schedule parameters into the hyperlink. The method includes the step of causing the hyperlink to open the webpage. The webpage comprises an embedded markup language geolocation method. While the webpage is open, using the embedded markup language geolocation method to call the geolocation API and obtain a geographical position of the driver/employee. The method includes the step of communicating the geographical position along with the identity of the employee/driver to a delivery tracking entity. The method includes steps for the webpage to make the geolocation API call periodically based on shift and logistics details embedded in the URL.

In another aspect, a method includes creating a virtual perimeter around a geographic region. The geographic region within the virtual perimeter is assigned a job-site number. A location of a user's mobile device is tracked. It is determined when a user enters the geographic region defined by the virtual perimeter. The time that the user is in the geographic region is recorded.

Optionally, the time the user is in the virtual perimeter can be assigned to a time sheet of the user as an employee of a company. It can be detected that the user has left the geographic region. The recording of the time that the user is in the geographic region can be ceased. The excused period to be outside the geographic region can be automatically determined from information in the user's mobile device calendar or in a list of assignments associated with the user. The geographic region can be a physical work site. An aggregated time that the user is in the geographic region for a specified period is provided as payroll information for the user for the specified period.

### BRIEF DESCRIPTION OF THE DRAWINGS

The present application can be best understood by reference to the following description taken in conjunction with the accompanying figures, in which like parts may be referred to by like numerals.

FIG. 1 depicts an example process of geofence-based automatic time clocking, according to some embodiments.

FIG. 2 depicts an example process of geofence-based automatic time clocking, according to some embodiments.

FIG. 3 illustrates an example report generated by a geofence-based time clocking, according to some embodiments.

FIG. 4 illustrates an example user-interface view of a region defined by a geo-fencing methodology, according to some embodiments.

FIG. 5 illustrates an example employee attendance record generated with geofence-based check-in and/or check-out service, according to some embodiments.

FIG. 6 illustrates an example user-interface view that enables a user (e.g. a supervisor) to create various jobsites with geofence-based check-in and/or check-out events, according to some embodiments.

FIG. 7 depicts an example user-interface view that enables an employee to check-in and/or check-out of a jobsite using text messaging with geofence-based verification, according to some embodiments.

FIG. 8 is a block diagram of a sample computing environment that can be utilized to implement some embodiments.

FIG. 9 depicts an exemplary computing system that can be configured to perform any one of the processes provided herein.

FIG. 10 illustrates an example process of using geofencing to generate a clock-in/clock out report for an employee, according to some embodiments.

FIGS. 11 A-B illustrate an example computerized process useful for geofence-based automatic time clocking.

FIG. 12 illustrates an example process for HTML5-based employee or transportation load tracking embellished with schedule/logistics-based rules, according to some embodiments.

FIG. 13 illustrates another example process for HTML5-based delivery tracking and logistics intelligence, according to some embodiments.

FIG. 14 illustrates an example text message generated on a server (e.g. based on employee id, schedule, tracking frequency etc.) and sent to a driver/employee, according to some embodiments.

FIGS. 15 and 16 illustrates an example set of screen shots of a text message and hyperlink, according to some embodiments.

FIG. 17 illustrates an example screen shot of a web portal view of work record, according to some embodiments.

The Figures described above are a representative set and are not an exhaustive with respect to embodying the invention.

### DESCRIPTION

Disclosed are a system, method, and article of field employee shift monitoring and transportation load tracking with markup language geolocation. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Barcode is an optical, machine-readable, representation of data; the data usually describes something about the object that carries the barcode.

ECMAScript is a scripting-language specification standardized by Ecma International in ECMA-262 and ISO/IEC 16262. JavaScript is an implementation of ECMAScript.

Geo-fence can be a virtual perimeter for a real-world geographic area. In various embodiments, a geo-fence can be dynamically generated (e.g. as in a radius around a store or point location specified by a system administrator and/or based on a job-related location). A geo-fence can be a predefined set of boundaries (e.g. a work-place zone(s), neighborhood boundaries, etc.). Custom-digitized geofences can also be utilized.

Geographic coordinate system geographic coordinate system is a coordinate system used in geography that enables every location on Earth to be specified by a set of numbers, letters or symbols. The coordinates can a vertical position, a horizontal position, etc. (e.g. latitude, longitude elevation etc.).

HTML 5 is a software solution stack that defines the properties and behaviors of web page content by implementing a markup-based pattern to it.

Landline telephone can be a telephone that uses a metal wire telephone line for transmission.

Location-based services (LBS) can be a class of computer program-level services that use location data to control features. LBS can use information of a geographical position of a mobile device. LBS can include tracking a mobile device's location.

Mobile device can be a portable computing device such as a smart phone, personal digital assistant, wearable computing device (e.g. smart watches and/or other electronic devices that are worn by the bearer under, with or on top of clothing), head-mounted display (e.g. smart glasses such as Google Glass®), tablet computer, and the like. Mobile devices can include systems for determining and/or assisting in determining a location of the mobile device (e.g. GPS, A-GPS, network-assisted location services, etc.).

QR code (Quick Response Code) is the trademark for a type of matrix barcode (or two-dimensional barcode). The QR barcode is a machine-readable optical label that contains information about the item to which it is attached. The QR code can uses various standardized encoding modes (e.g. numeric, alphanumeric, byte/binary, etc.) to store data efficiently; extensions may also be used.

Time clocking can include tracking the hours worked by an employee of a company.

### Process Overview

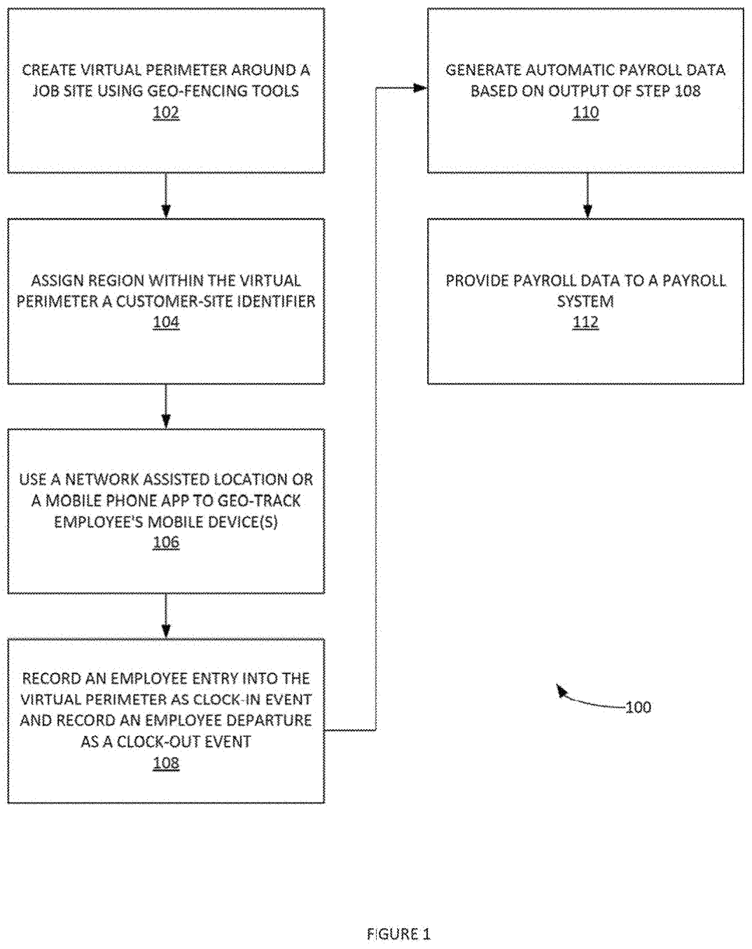

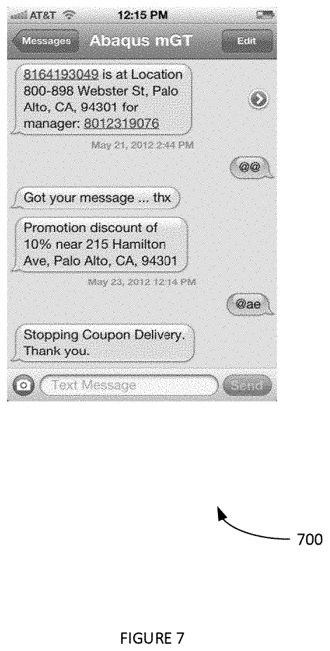

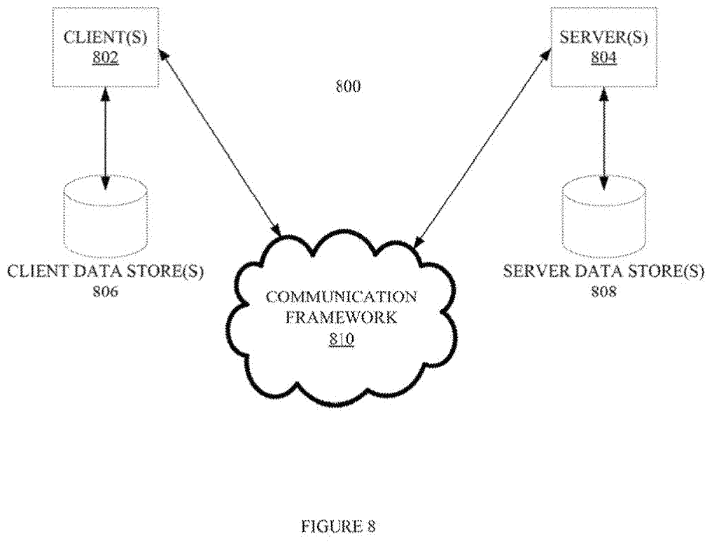

FIG. 1 depicts an example process 100 of automatic time clocking, according to some embodiments. In step 102 of process 100, a virtual perimeter can be created around a job site (e.g. a location where an employee performs employment-related activities). A job site can be a construction site, a delivery route, an office building, a school, etc. For example, geo-fencing methodologies can be implemented to define a region associated with a job site. In one example, virtual perimeters can be generated and defined by system administrators (e.g. supervisors, etc.). In another example, virtual perimeters can be automatically generated and defined based on such factors as a job location, job type (e.g. a city-wide virtual perimeter for a delivery driver, a room-sized virtual perimeter for an office worker, etc.). In step 104, the region within the virtual perimeter can be assigned a customer-site identifier. In this way, a customer of an entity that provides process 100 as a service can be differentiated from other customers. Employees of the customer can also be assigned identifier numbers. The employees can be geotracked (e.g. location determined on a periodic basis) in step 106. For example network-assisted location methods and/or a mobile device application can be used to obtain the employee's current location (e.g. assuming networking and processing latencies and the like). In step 108, an employee's entry into the region defined by the virtual perimeter can be recorded as a clock-in event (e.g. register employee's arrival at work). Similarly, an employee's departure from the region defined by the virtual perimeter can be recorded as a clock-out event (e.g. register employee's departure from work). In step 110, the output of step 108 can be used to automatically generate payroll data. In step 112, the payroll data can be provided to a payroll system (e.g. a customer's payroll system via an electronic message and/or an application programming interface (API)). It is noted that process 100 can be ‘zero touch’ in that employee clock-in and/or clock-out events are determined by an LBS (e.g. the location of the employee's mobile device). In another example, process 100 can be used in a text-based clock-in and/or clock-out system with LBS verification (e.g. see FIG. 7 infra). In another example, process 100 can be used in an interactive-voice based clock-in and/or clock-out system with double LBS verification.

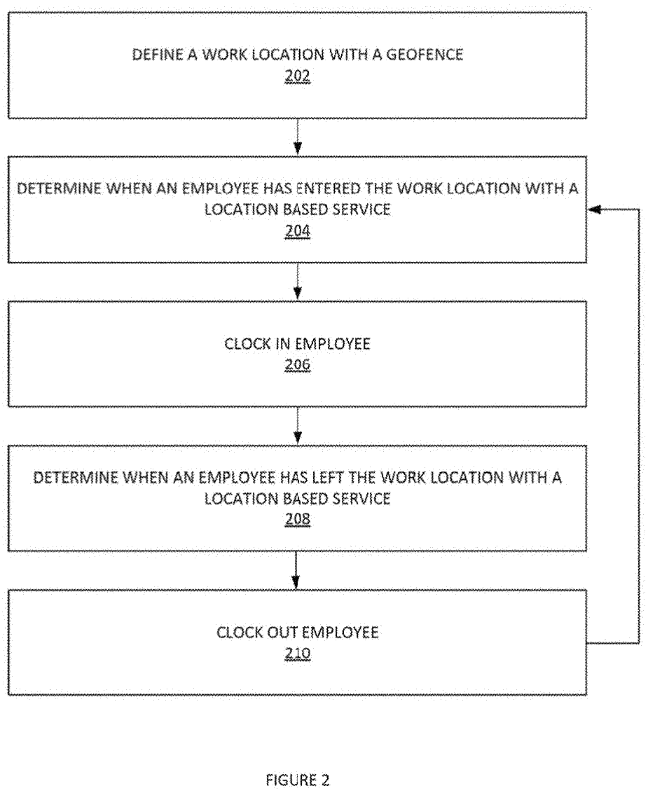

FIG. 2 depicts an example process 200 of geofence-based automatic time clocking, according to some embodiments. In step 202, a work location can be defined within a geofence. For example, see the region 402 defined in the user-interface view 400 provided infra. In step 204, it can be determined when an employee enters the work location. In step 206, the employee can be clocked in. While the employee is clocked-in, various attributes of the employee can be tracked with the LBS (e.g. speed, altitude, periods of non-movement, etc.). In step 208, it can be determined when an employee exits the work location. In step 210, the employee can be clocked out. Step 204-210 can be repeated.

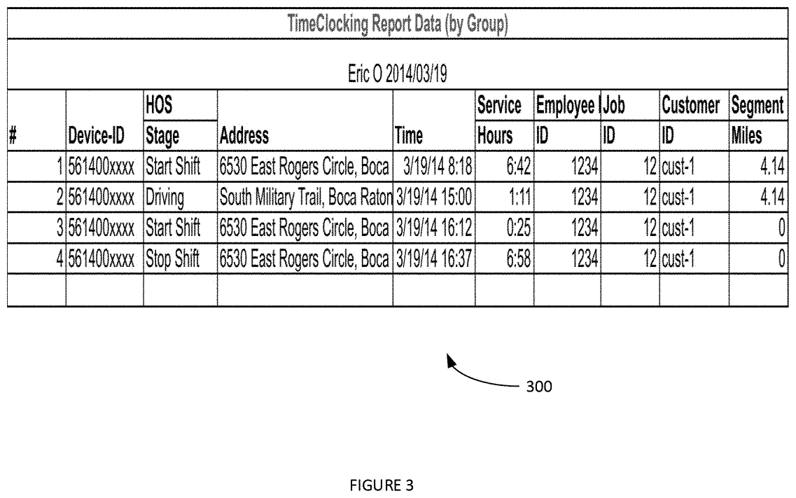

FIG. 3 illustrates an example report 300 generated by a geofence-based time clocking, according to some embodiments. Report 300 can be generated in a computer-readable form in step 110 of process 100. Report 300 can be generated by process 200 as well. Report 300 can include information such as, inter alia: a mobile device identifier, a type of each event, a location (e.g. an address) associated with each event, a time for each event, a duration of each event, an employee identifier associated with each event, a job identifier associated with each event, a customer identifier associated with each event, and/or distance attribute associated with each event. Report 300 is provided by way of example and not of limitation.

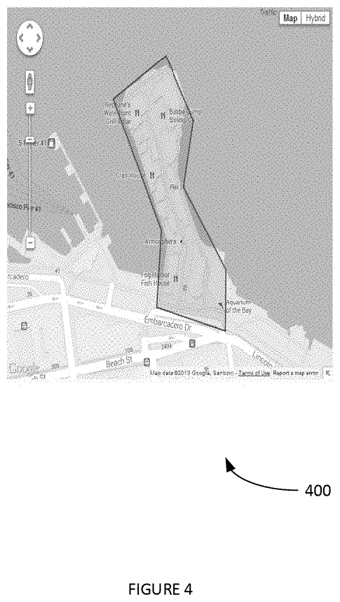

FIG. 4 illustrates an example user-interface view 400 of a region 402 defined by a geo-fencing methodology, according to some embodiments. The virtual boundaries can be view on the mapping service map. The user-interface view 400 can also include other information such as, inter alia: tracking of an employee phone; display of employee's clock-in and/or clock out events; modifications to virtual boundaries, an employee's z-axis (e.g. floor, story, height, altitude, etc.) etc. User-interface view 400 can be provided via various methods and systems such as, inter alia: a web page, a mobile device screen view provided with a mobile device application, an augmented-reality image, etc. Supervisors can utilize the system that provides user-interface view 400 to perform various actions and access various information. For example, a supervisor (and/or other system administrator) can setup a daily tracking schedule for the employee mobile device. The mobile device can include a digital camera and/or scanner for scanning relevant matrix codes. The supervisor can setup jobsites with customer code and/or payroll identifiers. The supervisor can automatically track start and/or stop events (e.g. clock-in and/or clock-out events) at a predetermined schedule. As a user (e.g. an employee) enters a jobsite, the service can automatically mark the entry as start of job shift. When the user leaves the job site, it can be marked as clock-out event. It is noted that a clock out during middle of the day can be marked as a ‘lunch’ or other predefined event (e.g. offsite meeting, break, errand to purchase goods and/or services, etc.). This excused time outside the job site can be counted the same as time within the job site. An employee's calendar and/or ‘to do’ list can be automatically checked when the employee leaves a job site. If these files indicate that the employee has a valid reason (e.g. break, errand, etc.) to be outside of the job site, the system can continue to keep the employee in a clocked-in state. The system can create a daily report with hours worked at the end of the day or at another specified time. Supervisors can access various employee information on a real-time basis.

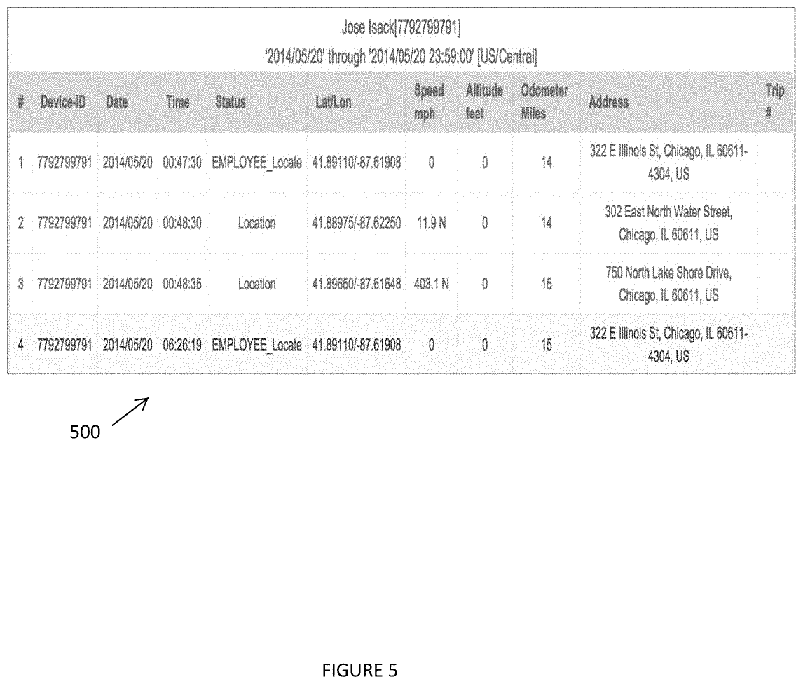

FIG. 5 illustrates an example employee attendance record 500 generated with geofence-based check-in and/or check-out service, according to some embodiments. A single employee's attendance record can be generated from information in a database maintained by the geofence-based check-in and/or check-out service. Attendance record 500 can be accessed by a customer of the geofence-based check-in and/or check-out service via an API and/or electronic message (e.g. emailed report, included in a text message, etc.). Attendance record 500 can include such information as, inter alia: device id, date, time, status, latitude/longitude, speed, altitude, odometer, address and/or trip number. The geofence-based check-in and/or check-out service can be automatically implemented with a computing system (e.g. one or more service, in a cloud-computing environment, etc.).

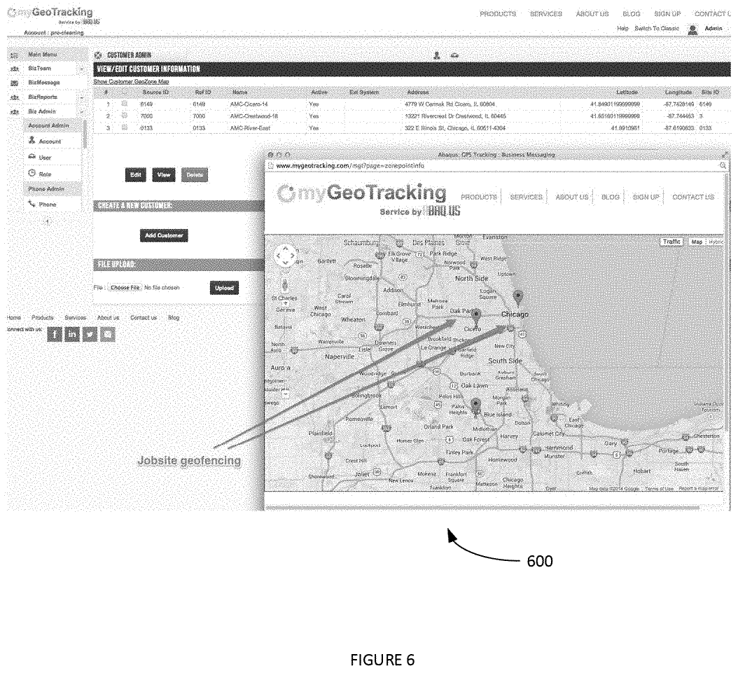

FIG. 6 illustrates an example user-interface view 600 that enables a user (e.g. a supervisor) to create various jobsites with geofence-based check-in and/or check-out events, according to some embodiments. Geofence regions can be created by various methods such as, inter alia: dragging and dropping various map coordinates (and/or other instructions) onto an image of a map, text input, pointer-based manipulation of map representations of virtual boundaries, dropping pins on a map and then defining areas around dropped pin, etc. In some examples, jobsite location can change dynamically (e.g. based on certain events such a location of repairs, deliveries, accidents, medical emergencies, nursing care, tutorials, education lessons, client visits, etc.). In these examples, a series of job sites can be defined in sequence and based on a schedule. The employee can record a check-in event by entering the job site only during a preset time slot (e.g. when a music lesson is scheduled in a home, when an in-house patient exam is scheduled in a home, when a delivery is scheduled in a client's office, etc.).

FIG. 7 depicts an example user-interface view 700 that enables an employee to check-in and/or check-out of a jobsite using text messaging with geofence-based verification, according to some embodiments. For example, the employee can checks-in/checks-out using text message (e.g. an SMS, MMS, augmented-reality based text message, etc.). The message can include the text ‘# checkin’. The employee can add a customer site name/code such as ‘task # # checkin <customer-name><task>’. The system can perform a location lookup of the employee's mobile device to verify attendance at the geo-fenced jobsite. The hours of service report can be generated with hours worked, on break, driving etc. (e.g. see report 300 of FIG. 3).

### Exemplary Environment and Architecture

FIG. 8 is a block diagram of a sample computing environment 800 that can be utilized to implement some embodiments. The system 800 further illustrates a system that includes one or more client(s) 802. The client(s) 802 can be hardware and/or software (e.g., threads, processes, computing devices). The system 800 also includes one or more server(s) 804. The server(s) 804 can also be hardware and/or software (e.g., threads, processes, computing devices). One possible communication between a client 802 and a server 804 may be in the form of a data packet adapted to be transmitted between two or more computer processes. The system 800 includes a communication framework 810 that can be employed to facilitate communications between the client(s) 802 and the server(s) 804. The client(s) 802 are connected to one or more client data store(s) 806 that can be employed to store information local to the client(s) 802. Similarly, the server(s) 804 are connected to one or more server data store(s) 808 that can be employed to store information local to the server(s) 804.

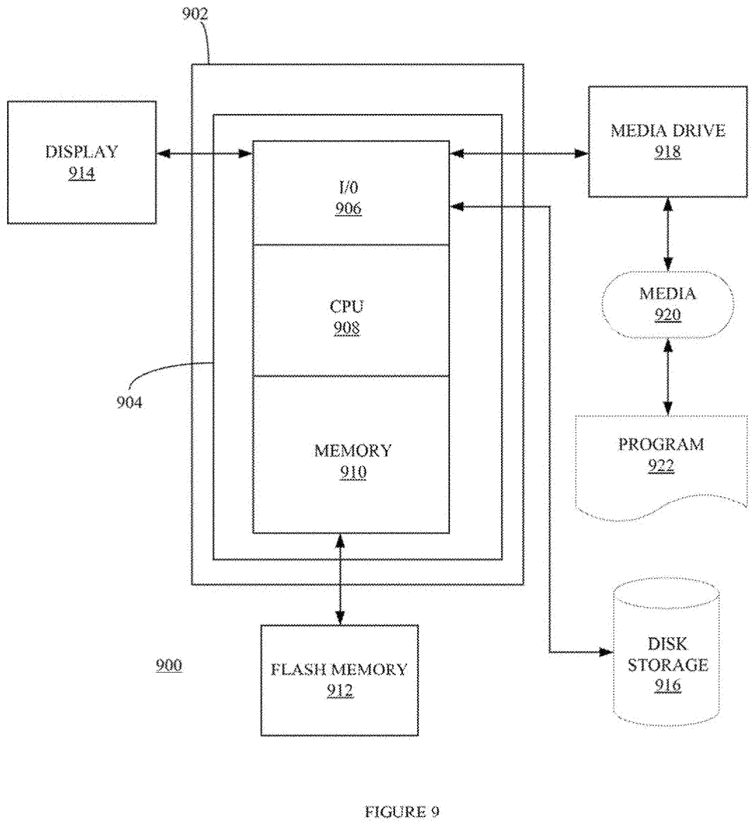

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. For example, computing system 900 can be configured to be a telecommunications server such as a payroll server and/or a location-aware geofence-based automatic time clocking server (e.g. can include API's and other systems to access data from the mobile device's network). In another example, computing system 900 can be configured as a mobile device and include such systems as may be typically included in a mobile device such as GPS systems, gyroscope, accelerometers, cameras, etc.

### Additional Methods

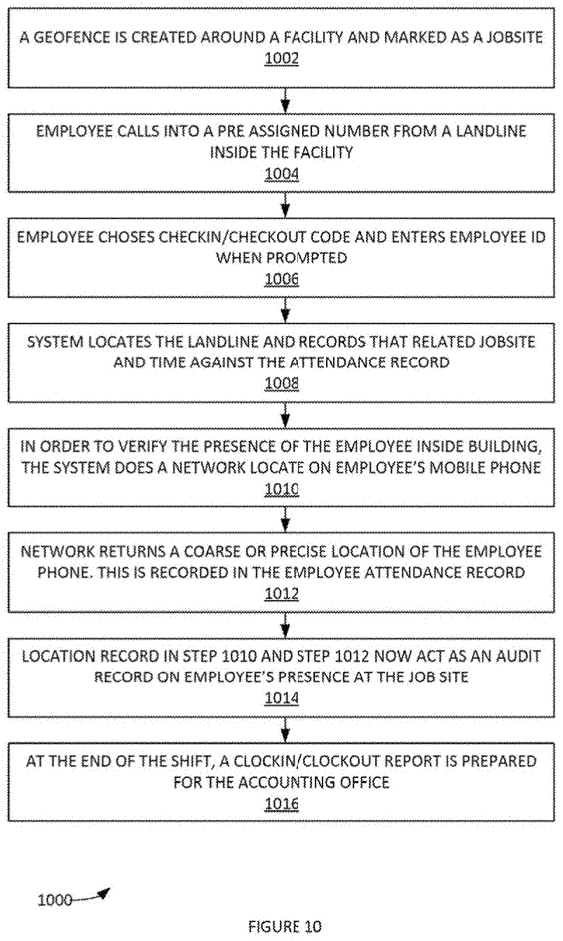

FIG. 10 illustrates an example process 1000 of using geofencing to generate a clock-in/clock-out report for an employee, according to some embodiments. In step 1002 of process 1000, a geofence is created around a facility and marked as a jobsite. In step 1004, an employee calls into a pre-assigned telephone number from a landline inside the facility. In step 1006, the employee chooses check-in/checkout code and enters Employee ID when prompted. In step 1008, the system locates the landline and records that related jobsite and time against the attendance record. In step 1010, in order to verify the presence of the employee inside the building, the system does a network locate on the employee's mobile phone. In step 1012, the network returns a coarse or precise location of the employee phone. This is recorded in the employee attendance record. In step 1014, the location record in step 1010 and step 102 can now act as an audit record on employee's presence at the job site. In step 1016, at the end of the shift, a clock-in/clock-out report is prepared for the accounting office. In one example, an employee ID can be used to lookup the mobile number of the employee. A network location can then be made against the mobile number of the employee. Additionally, in some examples, a company's scheduling system can be used to further enhance some of the automatic detection of activities throughout the day (e.g. such as check-in to a job site, lunch break, drive to pick up parts from Home Depot®, etc.). The attendance record of an activity list can be configured to feed into a company's payroll system.

Example methods of determining a z-axis are now discussed. The z-axis (e.g. what floor/story of a building an employee is working on) can be determined in the workforce management use-cases using a QR Code/bar code (e.g. any scannable matrix code, etc.). For example, a QR code can generated that includes information about a specific location in a building. This information can include, inter alia: room identifier, appliance identifier, floor/story identifier, room type/function, room name, etc. The QR code can be printed onto a sticker/label (or any other piece of printed paper, plastic, vinyl, or other material with pressure sensitive adhesive on one side, etc.) and made available for scanning.

In one example, a QR code (and/or other matrix code such as a bar code, etc.) can have indoor room details (e.g. second (2^{nd}) floor restroom #1 is printed and affixed inside the job site building). When the field service crew enters the premise, the members of the crew can clock into the job site by using the methods provided herein and/or by scanning the QR code to indicate arrival at the job site. They can then log various job tasks by scanning the QR and sending it to the back office using a mobile application, webpage, encoded text message, etc. This message can implicitly geotagged with location information (e.g. see supra) and/or combined with the scan information. Scan information would indicate Room1-Floor2. The uploaded info would then consist of the following, inter alia: telephone/cellphone number of the employee; timestamp; location (which can be detected using the phone's native location sensors and/or using a network telecom API for assisted-GPS/Cell tower etc.); QR scan (Room 2-1 for floor 2, room 1); task details; etc. The server can use this location to use geofencing algorithm to tag the job site name. The

A landline example is now provided. An employee can use a landline telephone number in indoor rooms/jobsites. The landline telephone can be previously configured to in the backend server as belonging to specific sites in the building (i.e. 2nd floor restroom #1). When a field-service crew enters the premise, they clock into to indicate arrival at the site. They then log various job tasks by using the landline to call a number and record their activities (IVR punches). The message is implicitly geotagged with location information (as outlined in the patent) combined with the landing location information. e.g. Room2-Floor1. The uploaded info would then consist of the following: telephone/cellphone number of the employee; timestamp; location (which can be detected using the telephone's native location sensors and/or using network telecom API for assisted-GPS/Cell tower etc.); telephone number of the indoor site (e.g. this can be translated to Room 2-1 in a backend database; task/job details. A server can use this location to use a geofencing algorithm to tag the job site name.

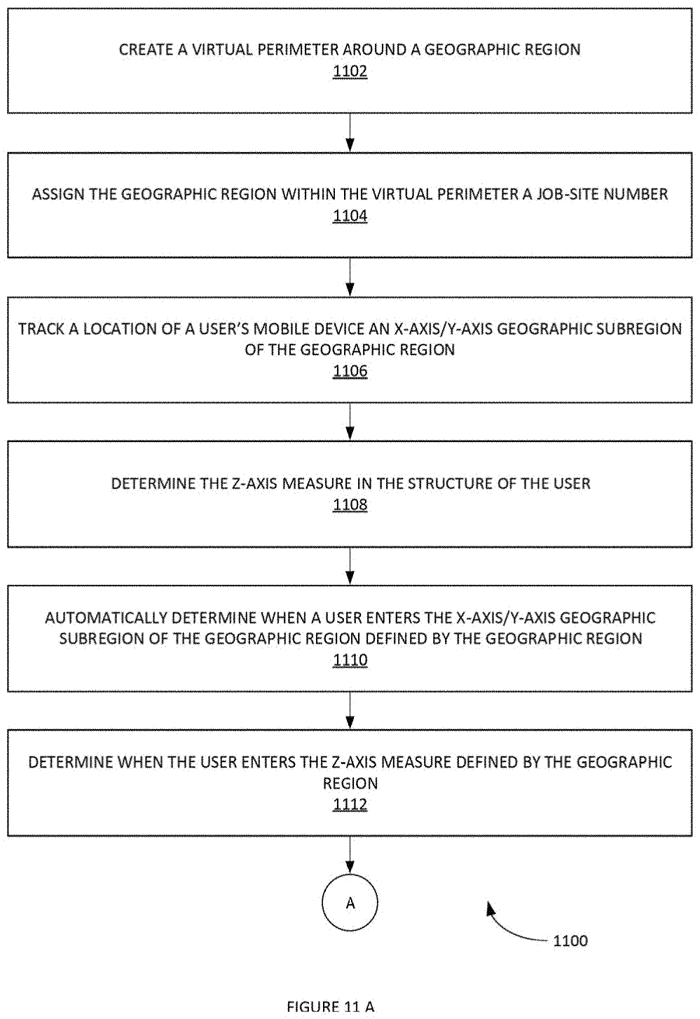

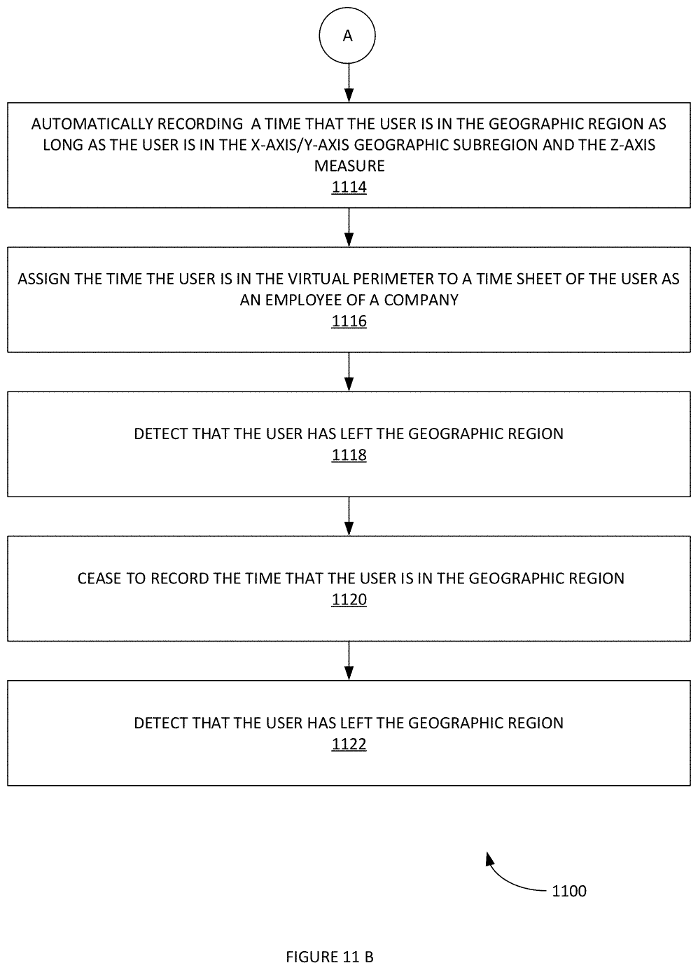

FIGS. 11 A-B illustrate an example computerized process 1100 useful for geofence-based automatic time clocking. In step 1102, process 1100 can create a virtual perimeter around a geographic region. The geographic region is defined with an x-axis/y-axis geographic coordinate system and a z-axis measure of a structure in the geographic region. In step 1104, process 1100 can assign the geographic region within the virtual perimeter a job-site number. In step 1106, process 1100 can track a location of a user's mobile device an x-axis/y-axis geographic subregion of the geographic region. In step 1108, process 1100 can determine the z-axis measure in the structure of the user. In step 1110, process 1100 can automatically determine when a user enters the x-axis/y-axis geographic subregion of the geographic region defined by the geographic region. In step 1112, process 1100 can determine when the user enters the z-axis measure defined by the geographic region. In step 1114, process 1100 can automatically recording a time that the user is in the geographic region as long as the user is in the x-axis/y-axis geographic subregion and the z-axis measure. In step 1116, process 1100 can assign the time the user is in the virtual perimeter to a time sheet of the user as an employee of a company. In step 1118, process 1100 can detect that the user has left the geographic region. In step 1120, process 1100 can cease to record the time that the user is in the geographic region. In step 1122, process 1100 can detecting that the user has left the geographic region.

In one aspect, a method includes creating a virtual perimeter around a geographic region. The geographic region within the virtual perimeter is assigned a job-site number. A location of a user's mobile device is tracked. It is determined when a user enters the geographic region defined by the virtual perimeter. The time that the user is in the geographic region is recorded.

Optionally, the time the user is in the virtual perimeter can be assigned to a time sheet of the user as an employee of a company. It can be detected that the user has left the geographic region. The recording of the time that the user is in the geographic region can be ceased. The excused period to be outside the geographic region can be automatically determined from information in the user's mobile device calendar or in a list of assignments associated with the user. The geographic region can be a physical work site. An aggregated time that the user is in the geographic region for a specified period is provided as payroll information for the user for the specified period.

In another aspect, a method includes geofencing a geographic region. A telephonic communication from a landline telephone used by an employee is received. The landline telephone is located in the geographic region. A check-in code from an employee input into the landline telephone during the telephonic communication is received. An employee identifier input into the landline telephone during the telephonic communication is received. The employee's mobile device is located. It is determined that employee's mobile device is within the geographic region. The employee is clocked in when both the check-in code from the landline telephone and the location of the mobile device indicate that the employee is within the geographic region.

In yet another aspect, a computerized method useful for geofence-based automatic time clocking includes the step of creating a virtual perimeter around a geographic region. The geographic region is defined with an x-axis/y-axis geographic coordinate system and a z-axis measure of a structure in the geographic region. The method includes the step of assigning the geographic region within the virtual perimeter a job-site number. The method includes the step of tracking a location of a user's mobile device an x-axis/y-axis geographic subregion of the geographic region. The method includes the step of determining the z-axis measure in the structure of the user. The method includes the step of automatically determining when a user enters the x-axis/y-axis geographic subregion of the geographic region defined by the geographic region. The method includes the step of determining when the user enters the z-axis measure defined by the geographic region. The method includes the step of automatically recording a time that the user is in the geographic region as long as the user is in the x-axis/y-axis geographic subregion and the z-axis measure. The method includes the step of assigning the time the user is in the virtual perimeter to a time sheet of the user as an employee of a company. The method includes the step of detecting that the user has left the geographic region; ceasing to record the time that the user is in the geographic region. The method includes the step of detecting that the user has left the geographic region.

HTML5-Based Delivery Tracking and Logistics

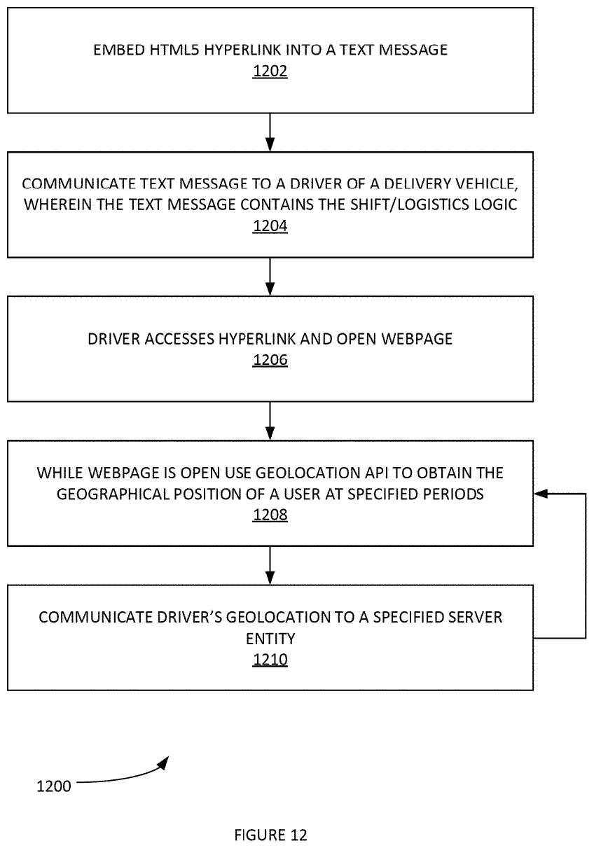

FIG. 12 illustrates an example process 1200 for HTML5-based delivery tracking and logistics, according to some embodiments. In step 1202, process 1200 can embed HTML5 hyperlink into a text message. The hyperlink opens a web page with an embedded html call to a geolocation API (e.g. a W3C Geolocation API, etc.). The text message can be communicated to a driver of a deliver vehicle when a load to deliver is picked up. The text message can be communicated to the driver when a geo-tracking entity wished to know the driver's geolocation.

In step 1204, process 1200 can communicate text message to a driver of a delivery vehicle. The text message contains work shift/logistics intelligence (e.g. employee ID, start time, end time, tracking cadence, etc.).

In step 1206, the driver accesses the hyperlink in the text message. The hyperlink opens the webpage. For example, the webpage can have an HTML Geolocation method embedded in it. In step 1208, while webpage is open, process 1200 uses the geolocation API to obtain the geographical position of a user at specified periods. The webpage can remain open in the background of other applications running on the mobile device.

In one example, the getCurrentPosition( ) method is used to return the user's position. Process 1200 can check if Geolocation is supported ad, if supported, process 1200 calls the getCurrentPosition( ) method. The getCurrentPosition( ) method returns the coordinates object to a function specified in the parameter (showPosition). The showPosition( ) function outputs the current Latitude and Longitude of the delivery driver.

The World Wide Web Consortium (W3C) Geolocation API can be an interface to retrieve the geographical location information for a client-side device. The W3C Geolocation API can define a set of objects, ECMAScript standard compliant, that executing in the client application provide the client's device location through the consulting of Location Information Servers, which are transparent for the application programming interface (API). Example sources of location information can include, inter alia: IP address, Wi-Fi and Bluetooth MAC address, radio-frequency identification (RFID), Wi-Fi connection location, and/or device Global Positioning System (GPS) and GSM/CDMA cell IDs. The location is returned with a given accuracy depending on the best location information source available.

The result of W3C Geolocation API can provide four (4) location properties, including latitude and longitude (coordinates), altitude (height), and accuracy of the position gathered, which all depend on the location sources. In some queries, altitude may yield or return no value. Location information ca be obtained by the mobile device (e.g. as a smartphone, PC or modem), which is then served by the API to be brought in browser. Usually geolocation will try to determine a device's position using one of these several methods.

In step 1210, process 1200 communicates the driver's geolocation (e.g. in terms of Latitude and Longitude to a specified server entity. In this way, the delivery driver's geolocation can be tracked while the webpage is open on the delivery driver's client-side device. It is noted that other HTML versions can be utilized in other example embodiments.

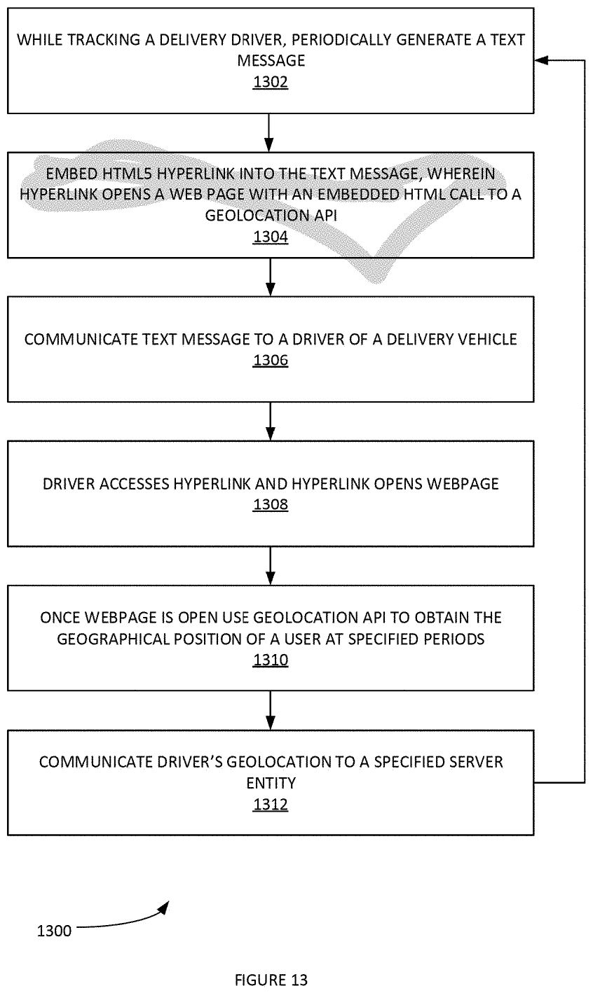

FIG. 13 illustrates another example process 1300 for HTML5-based delivery tracking and logistics, according to some embodiments. In step 1302, process 1300, while tracking a delivery driver, periodically generates a text message. In step 1304, process 1300 embeds HTML5 hyperlink into the text message, wherein hyperlink opens a web page with an embedded HTML call to a geolocation API. In step 1306, process 1300 communicates the text message to a driver of a delivery vehicle. In step 1308, process 1300 the driver accesses the hyperlink and the hyperlink opens a webpage. In step 1310, once webpage is open, process 1300 uses the geolocation API to obtain the geographical position of a user at specified periods. In step 1312, communicate driver's geolocation to a specified server entity. This can be server-side system that tracks delivery locations.

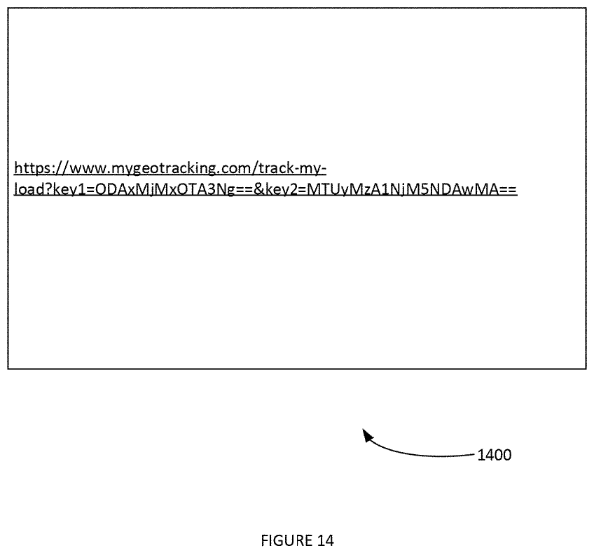

FIG. 14 illustrates an example text message 1400 generated on a server (e.g. based on employee id, schedule, tracking frequency etc.) and sent to a driver/employee, according to some embodiments. Text message 1400 can include a hyperlink. For example, process 1200 (and/or 1300) can automatically or manually send a text to the employee/driver's phone at the start of their shift (e.g. following an input ‘every day at 8 am send text to employee's phone’, etc.). The hyperlink leads to an HTML5 webpage which implicitly contains the work/logistics intelligence (e.g. Employee ID; START Tracking at Sam and STOP at 4 pm; Track every 1 hour, etc.). Based on driver's acceptance of tracking request, the HTML5 webpage can start to track the driver's smart phone (e.g. a mobile device, etc.) and stop when the shift ends. The web browser page can be in the foreground or can be in the background (e.g. based on employee's privacy setup). A variation on this process can be that the server can continuously send a request to check-in throughout the shift based on a pre-set cadence (e.g. send every 1 hour requesting the employee to clock-in, etc.).

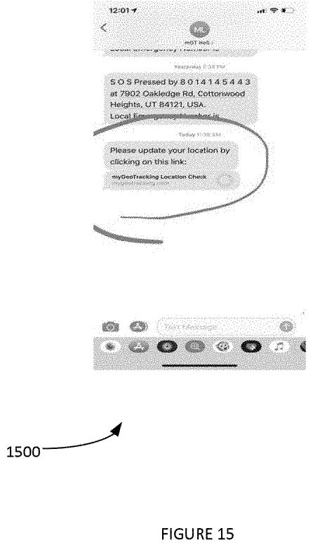

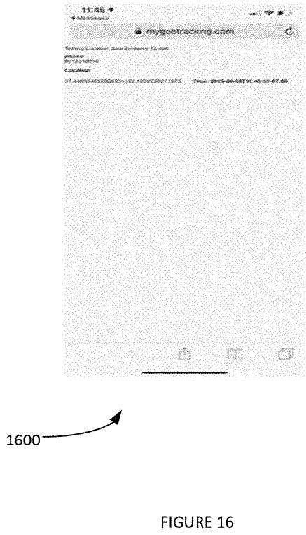

FIGS. 15 and 16 illustrates an example set of screen shots 1500 and 1600 of a text message and hyperlink, according to some embodiments. The driver/employee clicks on the link to create work record.

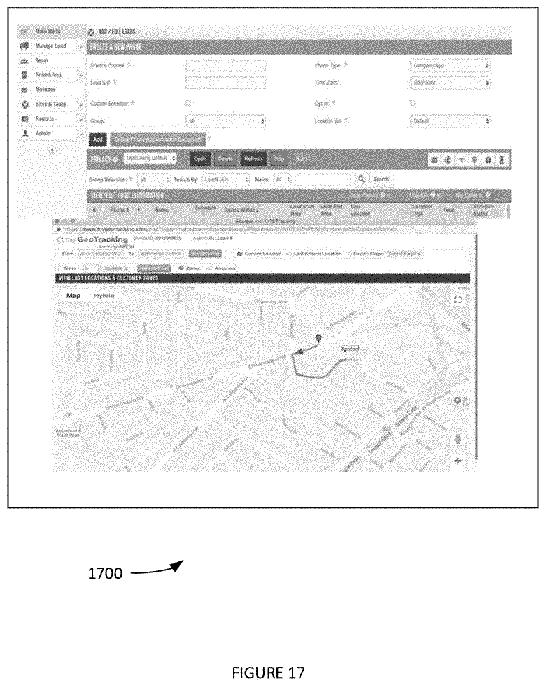

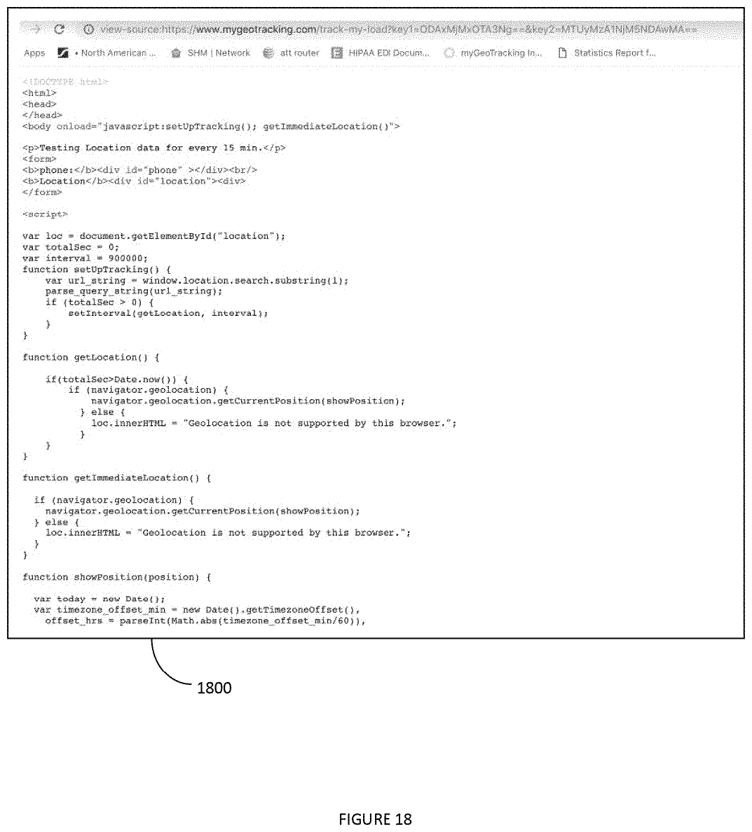

FIG. 17 illustrates an example screen shot 1700 of a web portal view of work record, according to some embodiments. A dispatch team can utilize the web portal to track the delivery.

FIG. 18 illustrates an example HTML5 web-page source code 1800 according to some embodiments. The HTML5 web-page source code 1800 is generated when the user clicks on the text link and consists of, inter alia: employees shift/load details, tracking frequency, employee ID.

In one example, a computerized method useful for implementing employee shift or transportation load tracking with the step of embedding a webpage-creation markup language hyperlink into a text message. The hyperlink includes encoded details of the employee ID, shift start/end time and tracking frequency request and opens a web page with an embedded markup language call to a geolocation application programming interface (API). The method includes the step of communicating the text message to a driver of a delivery vehicle. The method includes the step of displaying the text message to the driver with a mobile device of the driver. The method includes the step of detecting with the mobile device that the driver accessed the hyperlink in the text message. The method includes the step to embed logistics or shift parameters into the hyperlink. The method includes the step of causing the hyperlink to open the webpage. The webpage comprises an embedded markup language geolocation method. While the webpage is open, using the embedded markup language geolocation method to call the geolocation API and obtain a geographical position of the driver. The method includes the step of communicating the geographical position along with the identity of the employee/driver to a delivery tracking entity. The method includes steps for the webpage to make the geolocation API call periodically based on shift and logistics details embedded the URL.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for implementing employee shift or transportation load tracking of comprising:
embedding a webpage-creation markup language hyperlink into a text message, wherein the hyperlink opens a web page with an embedded markup language call to a geolocation application programming interface (API);
communicating the text message to a driver of a delivery vehicle;
displaying the text message to the driver with a mobile device of the driver;
detecting with the mobile device that the driver accessed the hyperlink in the text message;
causing the hyperlink to open the webpage, wherein the webpage comprises an embedded markup language geolocation method;
while the webpage is open, using the embedded markup language geolocation method to call the geolocation API and obtain a geographical position of the driver; and
communicating the geographical position of the driver to a delivery tracking entity.

2. The computerized method of claim 1, wherein the standard markup language comprises a Hypertext Markup Language (HTML) is the standard.

3. The computerized method of claim 2, wherein the HTML standard comprises an HTML5 standard.

4. The computerized method of claim 3, wherein the hyperlink opens the web page with an embedded HTML5 call to the geolocation API.

5. The computerized method of claim 4, wherein the text message is communicated to a driver of a deliver vehicle when a load to deliver is picked up.

6. The computerized method of claim 4, wherein the text message is communicated to the driver by a geo-tracking entity while the driver is in route while delivering the load.

7. The computerized method of claim 4, wherein the embedded markup language geolocation method comprises an HTML5 geolocation method that returns a latitude and longitude set of coordinates, an altitude height value, and an accuracy of the position gathered value.

8. The computerized method of claim 8 further comprising:
continuously running the web page in a background of the mobile device.

9. The computerized method of claim 8 further comprising:
using the HTML5 geolocation method to call the geolocation API and obtain the geographical position of the driver at a specified set of intervals.

10. A computer system for useful for implementing delivery tracking with a markup language for creating web pages comprising:
a processor configured to execute instructions;
a memory containing instructions when executed on the processor, causes the processor to perform operations that:
embed a webpage-creation markup language hyperlink into a text message, wherein the hyperlink opens a web page with an embedded markup language call to a geolocation application programming interface (API);
communicate the text message to a driver of a delivery vehicle;
display the text message to the driver with a mobile device of the driver;
detect with the mobile device that the driver accessed the hyperlink in the text message;
cause the hyperlink to open the webpage, wherein the webpage comprises an embedded markup language geolocation method; and
while the webpage is open, use the embedded markup language geolocation method to call the geolocation API and obtain a geographical position of the driver; and
communicate the geographical position of the driver to a delivery tracking entity.

11. The computerized system of claim 10, wherein the standard markup language comprises a Hypertext Markup Language (HTML) is the standard.

12. The computerized system of claim 11, wherein the HTML standard comprises an HTML5 standard.

13. The computerized system of claim 12, wherein the hyperlink opens the web page with an embedded HTML5 call to the geolocation API.

14. The computerized system of claim 12, wherein the text message is communicated to a driver of a deliver vehicle when a load to deliver is picked up.

15. The computerized system of claim 12, wherein the text message is communicated to the driver by a geo-tracking entity while the driver is in route while delivering the load.

16. The computerized system of claim 15, wherein the geolocation API comprises a W3C Geolocation API.

17. A computerized method useful for geofence-based automatic time clocking comprising:
creating a virtual perimeter around a geographic region, wherein the geographic region is defined with an x-axis/y-axis geographic coordinate system and a z-axis measure of a structure in the geographic region;
assigning the geographic region within the virtual perimeter a job-site number;
tracking a location of a user's mobile device an x-axis/y-axis geographic subregion of the geographic region;
determining the z-axis measure in the structure of the user;
automatically determining when a user enters the x-axis/y-axis geographic subregion of the geographic region defined by the geographic region;
determining when the user enters the z-axis measure defined by the geographic region;
automatically recording a time that the user is in the geographic region as long as the user is in the x-axis/y-axis geographic subregion and the z-axis measure;
assigning the time the user is in the virtual perimeter to a time sheet of the user as an employee of a company;
detecting that the user has left the geographic region;
ceasing to record the time that the user is in the geographic region; and
detecting that the user has left the geographic region.

18. The method of claim 17 further comprising:
determining that the user is utilizing an excused period to be outside the geographic region;
receiving a check-in code input from an employee input into the landline telephone during the telephonic communication, wherein after the check-in code is received:
locating the landline telephone;
verifying the location of the landline telephone is within a building within the jobsite;
performing a network locate operation on the user's mobile device to determine a location of the user's mobile device at the time the check-in code is received;
recording the location of the user's mobile device at the time the check-in code is received in the employee's attendance record;
receiving an employee identifier manually input into the landline telephone by the employee during the telephonic communication, and wherein the employee identifier is associated with each event associated with creating the virtual perimeter around the geographic region; and
wherein the excused period to be outside the geographic region is automatically determined from information in the user's mobile device calendar or in a list of assignments associated with the user,
wherein the geographic region comprises a physical work site, and
wherein an aggregated time that the user is in the geographic region for a specified period is provided as payroll information for the user for the specified period.

19. The computerized method of claim 18, wherein the geographic region comprises a job site.
